(19) United States
(12) Patent Application Publication
(10) Pub. No.: US 2012/0256383 A1
(43) Pub. Date: Oct. 11, 2012

(54) WHEEL FOR WHEELBARROWS AND CARTS

(75) Inventors: STEPHEN D. HATCHER, Camp Hill, PA (US); Eric Hyp, Harrisburg, PA (US)

(73) Assignee: AMES TRUE TEMPER, INC., CAMP HILL, PA (US)

(21) Appl. No.: 13/080,881

(22) Filed: Apr. 6, 2011

(51) Int. Cl. B62B 1/18; B60B 3/08; B60B 3/10

(52) U.S. Cl. 280/47.31; 301/7

(57) ABSTRACT

A wheel for a wheelbarrow wherein the wheel body forms wide spokes is provided. The spokes are formed by openings between the hub and the rim in the bodies that form the wheel. While such spokes are known, the openings that create the spokes provide additional points of entry for debris and water into the enclosed space. Thus, a sealed, fragmented seam coupling the wheel bodies is further provided.

### FIELD OF THE INVENTION

The present invention relates to a wheel for wheelbarrows and/or carts and, more specifically, to a wheel with spokes that is sealed against infiltration of debris and water.

### BACKGROUND OF THE INVENTION

Wheel assemblies for wheelbarrows include a wheel and a tire. Due to the work environments experienced by such wheel assemblies, the wheel must be very robust. Presently, wheelbarrow wheels are typically made from metal configured substantially as a disk having a central hub opening, a rim, and a solid body therebetween. A common alternative is to have two disk-like bodies that are joined together. The bodies may be convex, or have convex portions, whereby, when the bodies are joined, the wheel forms an enclosed space. That is, the disk-like bodies are joined at the outer surface, i.e. about the rim, and about the hub opening. This configuration creates a substantially sealed, enclosed space. The sealing of the hub enclosed space is important as a cause of wheel and/or tire failure is the infiltration of debris and water into the enclosed space. While such wheel assemblies serve their purpose, the full disk-like body, which is typically made from metal, are both heavy and expensive, and are not generally considered to be aesthetically pleasing.

### SUMMARY OF THE INVENTION

The disclosed and claimed concept provides for a wheel for a wheelbarrow wherein the wheel body forms wide spokes. The spokes are formed by openings between the hub and the rim in the bodies that form the wheel. While such spokes are known, the openings that create the spokes provide additional points of entry for debris and water into the enclosed space. Thus, the disclosed and claimed concept further provides for a sealed, fragmented seam on the wheel bodies. That is, the seam is the gap between the wheel bodies. This seam is fragmented as it is divided into a plurality of openings. When the seam is sealed, there is no, or no substantial, entry point into the wheel enclosed space. The seam is, preferably, sealed by a hemmed-over inwardly extending rib that extends about each opening. Alternatively, the rib may be an axially, inwardly extending rib that abuts a similar rib on the opposing body or contacts the opposing body. Another alternative is a grommet that extends about each opening. In any of these configurations, the openings are substantially sealed, thereby substantially resisting the infiltration of debris and water.

### BRIEF DESCRIPTION OF THE DRAWINGS

A full understanding of the invention can be gained from the following description of the preferred embodiments when read in conjunction with the accompanying drawings in which:

FIG. 1 is an isometric view of a wheelbarrow.

FIG. 2 is an exploded view of the wheel.

FIG. 3 is an cross-sectional view of the wheel.

FIG. 4 is an cross-sectional view of spoke.

FIG. 5 is an isometric detail view of an alternate embodiment.

FIG. 6 is a cross-sectional view of a spoke in an alternate embodiment.

FIG. 7 is a cross-sectional view of a spoke in an alternate embodiment.

FIG. 8 is a cross-sectional view of a spoke in an alternate embodiment.

### DESCRIPTION OF THE PREFERRED EMBODIMENTS

As used herein, “coupled” means a link between two or more elements, whether direct or indirect, so long as a link occurs.

As used herein, “directly coupled” means that two elements are directly in contact with each other.

As used herein, “fixedly coupled” or “fixed” means that two components are coupled so as to move as one while maintaining a constant orientation relative to each other. The fixed components may, or may not, be directly coupled.

As used herein, the word “unitary” means a component is created as a single piece or unit. That is, a component that includes pieces that are created separately and then coupled together as a unit is not a “unitary” component or body.

As used herein, a “rim” is a body shaped substantially as a torus and having one or more fellies.

As used herein, and in reference to the ribs disposed at each window, “inwardly” means that the rib extends into the space defining the window.

As used herein, and in reference to the ribs disposed at each window, “axially, inwardly” means that the rib extends into the enclosed space between two wheel bodies.

As used herein, “associated” means that the identified components are related to another component and/or interact with each other. For example, a body that has a plurality of spokes includes a space between adjacent spokes, thus the two adjacent spokes are “associated” with the space therebetween. A component may be independently “associated” with more than one other component. For example, a first spoke is “associated” with the spaces and adjacent spokes located both clockwise and counterclockwise thereto. This does not mean, however, that the two other spokes are “associated” with each other; rather the first spoke is independently “associated” with each space and adjacent spoke.

As used herein, and with reference to a rib, the “height” of a rib means the distance from the base, or proximal end, of the rib to another point on the rib.

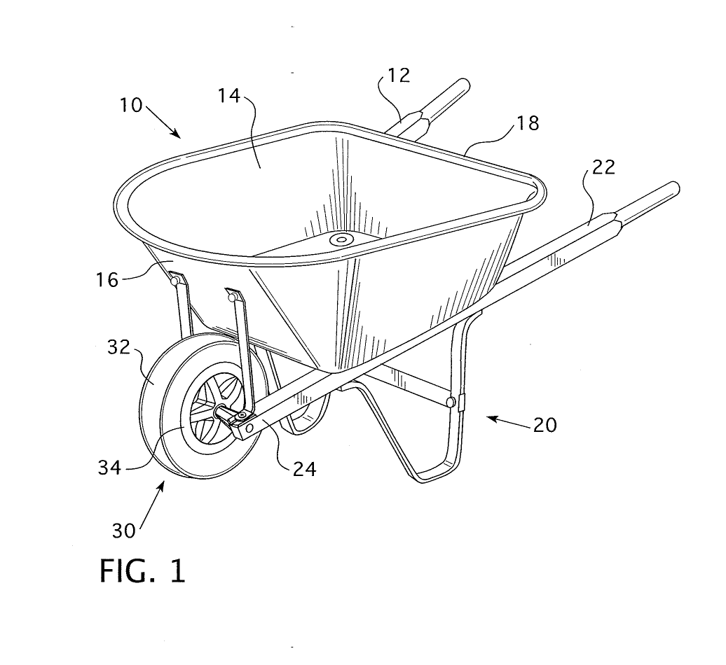

As shown in FIG. 1, a wheelbarrow 10 includes a frame assembly 12 and a tray 14. The tray has a front side 16 and a rear side 18. The frame assembly 12, which includes a plurality of elongated members 20, forms a handle assembly 22 and a yoke 24. The handle assembly 22 is disposed at the tray rear side 18 and the yoke 24 is disposed under the tray front side 16. The yoke 24 includes two spaced frame members 20. The frame assembly 12 includes a wheel assembly 30. The wheel assembly 30 includes a bearing 31, a tire 32 and a wheel 34. The tire 32 may be inflatable, solid, or partially solid and is disposed about the wheel 34.

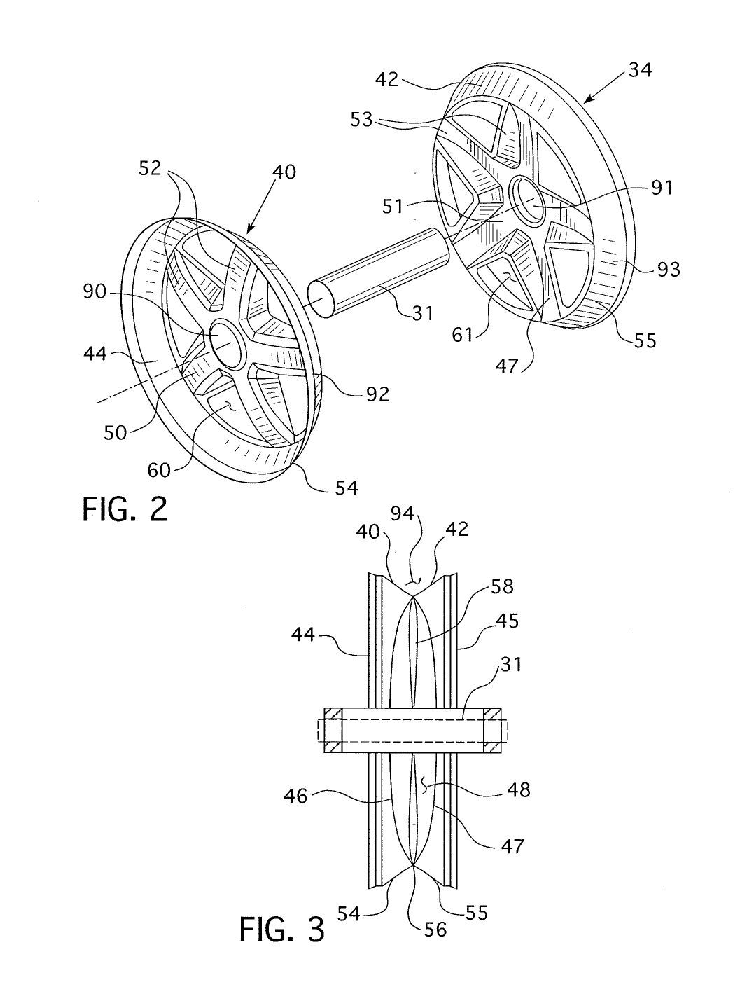

As shown in FIGS. 2 and 3, the wheel 34 includes a first body 40 and a second body 42. Except as noted below, the wheel first and second bodies 40, 42 are substantially similar and/or a mirror image of each other. The wheel first and second bodies 40, 42 are generally disk-like, but also have a generally convex shape and/or convex portions. The wheel first and second bodies 40, 42 each have an outer side 44, 45 and an inner side 46, 47. The wheel first and second bodies 40, 42 are coupled with the inner sides 46, 47 facing each other. The convex shape of the wheel first and second bodies 40, 42 thereby form an enclosed space 48.

The wheel first and second bodies 40, 42 each include a hub 50, 51, as shown in FIG. 2, a plurality of radial spokes 52, 53, and a rim 54, 55. Each hub 50, 51 includes opening 90, 91. Each rim 54, 55 is a torus defined by a sidewall 92, 93. The sidewalls 92, 93 are angled, ninety degrees, or less as shown, toward the associated wheel body outer side 44, 45. When the wheel bodies 40, 42 are coupled, the two rims 54, 55 form a channel 94 in which the tire 32 is partially disposed. It is noted that between the wheel first and second body rims 54, 55 there is a continuous seam 56, that is, a narrow gap or interface between the two bodies 40, 42. This continuous seam 56 is sealed. Further, when the wheel first and second bodies 40, 42 are coupled together, the hub openings 90, 91 are aligned. The bearing 31 is disposed in the hub openings 90, 91 and defines an axis of rotation for the hub 50, 51 and, therefore for the wheel 34.

The spokes 52, 53 extend between the associated hub 50, 51 and the associated rim 54, 55. Each spoke 52, 53, preferably, has a convex cross-section. Thus, when the wheel first and second bodies 40, 42, are coupled to each other, each spoke 52, 53 defines part of the enclosed space 48. Between each spoke 52, 53 and an adjacent spoke 52, 53 (on the same wheel body 40, 42) there is a space. The space between adjacent spokes 52, 53 and bounded by the portion of the rim 54, 55 between the adjacent spokes 52, 53 define a window 60, 61.

Each window 60, 61 has a rib 62, 63. That is, each side of a spoke 52, 53 has a rib 62, 63 which continues over the portion of the rim 54, 55 between the spokes 52, 53. As this space is defined as a window 60, 61, the following description shall identify the rib 62, 63 as being associated with the window 60, 61. Each first wheel body window 60 has a first rib 62 and each second wheel body window 61 has a second rib 63. Each rib 62, 63 extends substantially about, i.e. completely around, the associated window 60, 61. It is understood that each window 60, 61 and associated rib 62, 63 on each wheel body 40, 42 are substantially similar. Thus, the following description shall address a single pair of windows 60, 61 but it is further understood that the description applies to all windows 60, 61.

When the wheel bodies 40, 42 are coupled, the mirror image spokes 52, 53 are aligned with each other. Thus, the windows 60, 61 between adjacent spokes 52, 53 are aligned as well. When the wheel bodies 40, 42 are coupled, there is a seam or narrow gap/interface between the two bodies 40, 42 at each window 60, 61. Each seam is a path for debris and/or water into the enclosed space 48. Hereafter, the group of seams created at the windows 60, 61 shall be identified collectively as a “fragmented seam” 58. To prevent the infiltration of debris, water or any other contaminant; the fragmented seam 58 is sealed.

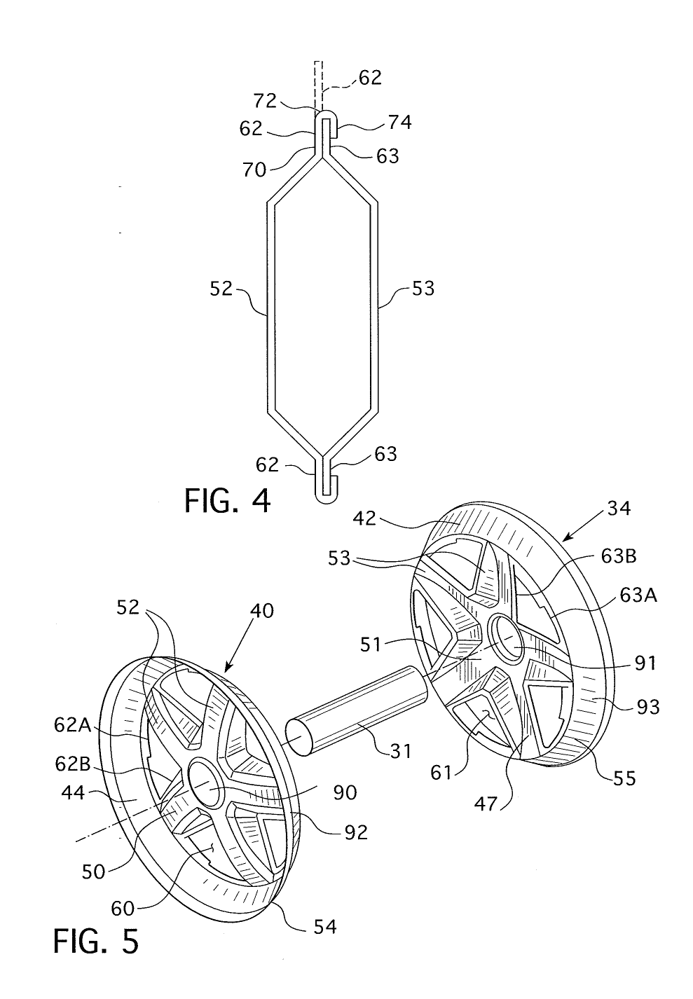

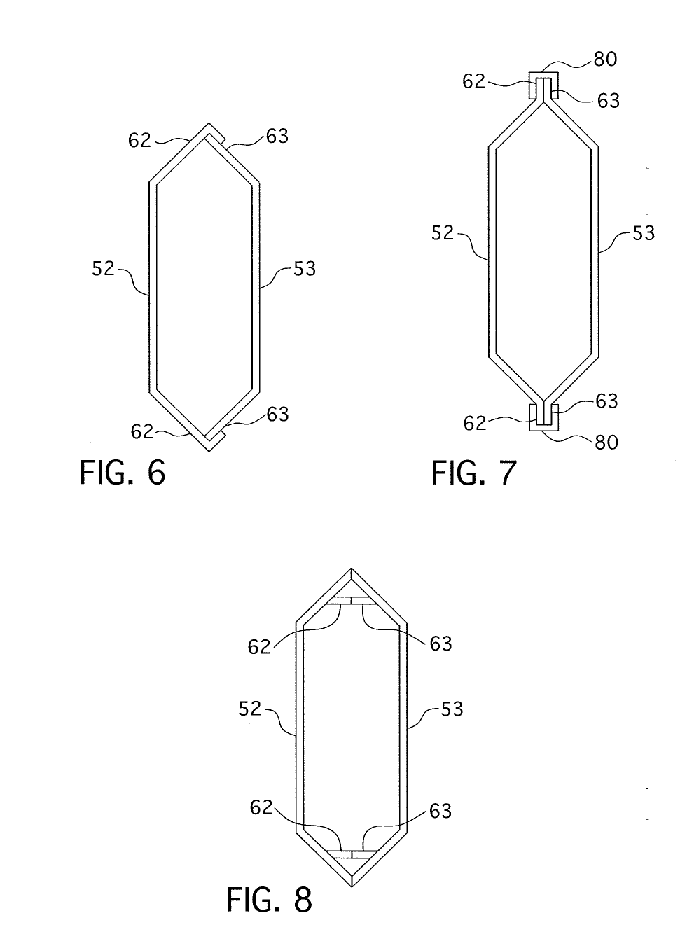

In a first embodiment, Shown in FIG. 4, the rib 62, 63 in each window 60, 61 extends inwardly; i.e. into the window and, preferably, generally perpendicular to the axis of rotation of the wheel 34. It is noted that in each figure showing a cross-section of a spoke 52, 53, the ribs 62, 63 on one side of the spoke 52, 53, e.g. the upper side vs. the lower side as shown, are in a different window 60, 61 than the ribs 62, 63 on the lower side of the spoke 52, 53, as discussed above.

In a first variation (FIG. 4), the first body first rib 62 extends further inwardly than the second body second rib 63. When the wheel bodies 40, 42 are being coupled and the windows 60, 61 are aligned, the first body first rib 62 extends further into the associated window 60, as shown in ghost. The first body first rib 62 extends at least, and preferably more than, the thickness of the second body second rib 63. In this configuration the first body first rib 62 may be folded over the second body second rib 63, thereby coupling the wheel bodies 40, 42 but also sealing the windows 60, 61.

More specifically, the first body first rib 62 has three portions, a proximal portion 70, a transition portion 72, and a distal portion 74. The first body first rib proximal portion 70 has a height, as defined above, substantially equal to the height of the second body second rib 63. The first body first rib transition portion 72 has a height substantially equal to the thickness of the second body second rib 63. The first body first rib distal portion 74 has a height that is, preferably, less than the height of the second body second rib 63 and, more preferably, about half the height of the second body second rib 63. In this configuration, the first body first rib 62 may be folded over the second body second rib 63 and, more specifically, the folded over distal portion 74 extends over about half of the second body second rib 63. That is, the folded over distal portion 74 preferably extends from the distal end of the second body second rib 63 to about a mid-point of the second body second rib 63.

During assembly, the wheel first and second bodies 40, 42 are placed adjacent to each other with the inner sides 46, 47 facing each other. Preferably, the two ribs 62, 63 are immediately adjacent each other and/or in contact with each other. The first body first rib 62 is then folded over the second body second rib 63, bending at the interface between the first body first rib proximal portion 70 and the first body first rib transition portion 72. Once the first body first rib proximal portion 70 and the first body first rib transition portion 72 are at about a right angle to each other, the bending at the interface between the first body first rib proximal portion 70 and the first body first rib transition portion 72 is stopped. The first body first rib 62 is then bent at the interface between the first body first rib transition portion 72 and the first body first rib distal portion 74. The bending at the interface between the first body first rib transition portion 72 and the first body first rib distal portion 74 continues until the first body first rib distal portion 74 sealingly engages the second body second rib 63 and/or the two ribs 62, 63 sealingly engage each other at the interface of their inner sides.

It is noted that, because the windows 60, 61 have a curved perimeter, the first body first rib distal portion 74 may be swaged at any corner. That is, the material forming the first body first rib distal portion 74 may be thinned so as to cover the radial portions of the window 60, 61 perimeter. Alternatively, the first body first rib distal portion 74 may be split at the radial portions of the window 60, 61 perimeter so long as the split does not extend to the first body first rib transition portion 72.

In this configuration, the hemming, or coupling by bending, of the first body first rib 62 accomplishes two tasks: first the two ribs 62, 63 couple the wheel first and second bodies 40, 42 together. Second, because the two ribs 62, 63 sealingly engage each other, either at the interface of the first body first rib distal portion 74 and the second body second rib 63 and/or at the interface of the inner side of the two ribs 62, 63, the hemming further seals access at the windows to the enclosed space 48. While typically not required, a sealing agent, or gasket, may be disposed between the two ribs 62, 63 at either the interface of the first body first rib distal portion 74 and the second body second rib 63 and/or at the interface of the inner side of the two ribs 62, 63, so as to ensure a complete seal.

In the variation described above, the two wheel bodies 40, 42 are different in that the first body first rib 62 has a different height than the second body second rib 63. In another variation, the two wheel bodies 40, 42 may be identical to each other. In this variation the longer rib 62 is split between the two wheel bodies 40, 42. That is, as shown in FIG. 5, the first body first rib 62 has an extended portion 62A and a shortened portion 62B. The extended portion 62A extends along one spoke 52 and half of the portion of the rim 54 of the pair of windows 60 associated with the spoke 52. The extended portion 62A has a height greater than the shortened portion 62B. That is, the extended portion 62A has a height sufficient to be folded over the associated shortened portion 63B, discussed below. In this instance, the wheel first and second bodies 40, 42 are identical and are not mirror images. Thus, the second wheel body 42 also has a second body second rib 63 with an extended portion 63A and a shortened portion 63B. The extended portion 63A extends along one spoke 53 and half of the portion of the rim 55 of the pair of windows 61 associated with the spoke 53.

When these two windows 60, 61 are aligned and the wheel first and second bodies 40, 42 are placed adjacent to each other with the inner sides 46, 47 facing each other, the first body first rib extended portion 62A is aligned with the second body second rib shortened portion 63B, and vice-versa. In this configuration, each extended portion 62A, 63A may be hemmed over the aligned shortened portion 62B, 63B. Because the extended portion 62A, 63A is split, this variation preferably includes a gasket or sealing material (not shown).

In a second variation, the first body first rib 62 and the second body second rib 63 have substantially the same height. In this variation, however, the two ribs 62, 63 are not generally perpendicular to the axis of rotation of the wheel 34. Instead, the two ribs 62, 63 are angled toward each other, i.e. each rib 62, 63 is angled toward the inner side 46, 47 of the associated wheel body 40, 42. As before, during assembly, the wheel first and second bodies 40, 42 are placed adjacent to each other with the inner sides 46, 47 facing each other. When wheel first and second bodies 40, 42 are coupled, e.g. by welding the continuous seam 56 at the interface of the wheel first and second body rims 54, 55, the two ribs 62, 63 are in sealing contact with each other. As before, a sealing agent, or gasket, may be disposed between the two ribs 62, 63 at the interface of the inner side of the two ribs 62, 63, so as to ensure a complete seal.

In another embodiment, shown in FIG. 7, the rib 62, 63 in each window 60, 61 extends inwardly; i.e. into the window 60, 61 and, preferably, generally perpendicular to the axis of rotation of the wheel 34. The first body first rib 62 and the second body second rib 63 have substantially the same height. Each first body first rib 62 and each second body second rib 63 extend about the perimeter of each associated window. During assembly, the wheel first and second bodies 40, 42 are placed adjacent to each other with the inner sides 46, 47 facing each other. Preferably, the two ribs 62, 63 are immediately adjacent each other and/or in contact with each other. In this configuration, the wheel assembly 30 includes a plurality of grommets 80. The grommets 80 are loops shaped to correspond to the shape of the windows 60, 61. As before, in the following discussion only a single, aligned pair of windows 60, 61 will be addressed, and therefore only a single grommet 80 will be discussed. It is understood that each aligned pair of windows 60, 61 has its own grommet 80.

The grommet 80, when viewed in cross-section as in FIG. 7, are U-shaped, with the open side facing outwardly. Thus, the grommet 80 may be placed over the fragmented seam 58 located at each aligned pair of windows 60, 61. That is, because the two ribs 62, 63 have substantially the same height and are disposed immediately adjacent each other and/or in contact with each other, the two ribs 62, 63 may be disposed in the groove of the grommet 80. The grommet 80 is structured to sealingly engage the pair of ribs 62, 63. In this configuration, the fragmented seam 58 disposed about the pair of windows 60, 61 is sealed.

In another embodiment, shown in FIG. 8, the pair of ribs 62, 63 extend axially inwardly. That is, each of the pair of ribs 62, 63 are disposed about the perimeter of a window 60, 61, but extend generally parallel to the axis of rotation for the wheel 34 and toward the inner side 46, 47 of each wheel body 40, 42. In this configuration, and during assembly when the wheel first and second bodies 40, 42 are placed adjacent to each other with the inner sides 46, 47 facing each other, the two ribs 62, 63 extend toward each other. Thus, when the wheel first and second bodies 40, 42 are coupled, e.g. as described above, the pair of ribs 62, 63 abut, i.e. are directly coupled to, each other in a sealing manner. To ensure that there are no paths of entry for debris and water, each first body first rib 62 and each second body second rib 63 extend substantially about each associated window 60, 61.

The ribs 62, 63 may be configured complimentary to each other. That is, as used herein “complimentary to each other” means that the two ribs 62, 63 together extend about the entire perimeter of the aligned pair of windows 60, 61. For example, the wheel first body 40 may include an axially inwardly extending rib 62 along both spokes 52 associated with a window 60. While the wheel second body 42 has the second body second rib 63 extending about the portion of the rim associated with the window 61. When the wheel first and second bodies 40, 42 are placed adjacent to each other with the inner sides 46, 47 facing each other, the complimentary ribs 62, 63 form a seal about the aligned windows 60, 61. It is noted that the ends of each rib 62, 63 may be shaped, e.g. cut at a 45 degree angle, to engage each other.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A wheel for a wheelbarrow, said wheelbarrow having a frame assembly and a tray, said tray having a front side and a back side, said tray coupled to said frame assembly, said frame assembly having a plurality of elongated frame members, said frame members forming a handle assembly at said tray back side and a yoke at said tray front side, said wheel comprising:
a first body having an outer side and an inner side, said body including a hub with an axis of rotation, a plurality of radial spokes and a rim, said plurality of spokes having a space between adjacent spokes, each said space being a window defined by opposing sides of adjacent spokes and the inner edge of said rim, each said window having a first rib;
a second body having an outer side and an inner side, said body including a hub with an axis of rotation, a plurality of radial spokes and a rim, said plurality of spokes having a space between adjacent spokes, each said space being a window defined by opposing sides of adjacent spokes and the inner edge of said rim, each said window having a second rib;
said first body coupled to said second body with both said inner sides facing each other, said first body and said second body coupled along a fragmented seam; and
said fragmented seam being sealed.

2. The wheel of claim 1 wherein:
said first body and said second body both being at least partially convex;
said first body and said second body coupled at a continuous seam disposed at said first body rim and said second body rim; and
whereby, when coupled, said first body and said second body define a sealed, enclosed space.

3. The wheel of claim 2 wherein:
each said first body first rib and each said second body second rib are inwardly extending ribs;
each said first body first rib and each said second body second rib extending substantially about each associated window;
each said first body first rib extends further inwardly than said second body second rib; and
said first body and said second body being coupled to each other with said first body spokes being aligned with said second body spokes and with each said first body first rib being sealingly folded over each aligned second body second rib.

4. The wheel of claim 3 wherein:
said second body second rib extends in a plane substantially perpendicular to said second body hub axis of rotation;
said first body first rib having three portions, a proximal portion, a transition portion, and a distal portion;
said first body first rib proximal portion extending in a plane substantially perpendicular to said first body hub axis of rotation;
said first body first rib proximal transition portion extending and bending over said second body second rib; and
said first body first rib distal portion extending in a plane substantially parallel to, but spaced from, said first body first rib proximal portion.

5. The wheel of claim 2 wherein:
each said first body first rib and said second body second rib are axially inwardly extending ribs, each said first body first rib and said second body second rib being positioned so that when said windows are aligned, each said first body first rib is substantially aligned with an opposing second body second rib; and
wherein, when said first body and said second body are coupled, each said first body first rib and each said second body second rib is coupled to an opposing rib.

6. The wheel of claim 5 wherein each said first body first rib and each said second body second rib are directly coupled to each other.

7. The wheel of claim 5 wherein each said first body first rib and each said second body second rib extend substantially about each associated window.

8. The wheel of claim 5 wherein:
each said first body first rib and each said second body second rib extending partially about each associated window; and
each said first body first rib and each said second body second rib being complimentary to each other.

9. The wheel of claim 8 wherein each said first body first rib and each said second body second rib extend over about half of each associated window perimeter.

10. The wheel of claim 2 wherein:
each said first body first rib and each said second body second rib are inwardly extending ribs;
each said first body first rib and each said second body second rib extending about the perimeter each associated window;
each said first body first rib and said second body second rib extending substantially the same distance into the associated window;
a plurality of grommets, said grommets being loops shaped to correspond to said windows; and
one said grommet disposed in each said window and sealingly engaging both said first body first rib and said second body second rib in each associated window.

11. A wheelbarrow comprising:
a frame assembly, said frame assembly having a plurality of elongated frame members, said frame members forming a handle assembly and a yoke;
a tray, said tray having a front side and a back side, said tray coupled to said frame assembly,
a wheel rotatably coupled to said frame assembly at said yoke, said wheel having a first body, a second body, and bearing;
a first body having an outer side and an inner side, said body including a hub with an axis of rotation, a plurality of radial spokes and a rim, said plurality of spokes having a space between adjacent spokes, each said space being a window defined by opposing sides of adjacent spokes and the inner edge of said rim, each said window having a first rib;
a second body having an outer side and an inner side, said body including a hub with an axis of rotation, a plurality of radial spokes and a rim, said plurality of spokes having a space between adjacent spokes, each said space being a window defined by opposing sides of adjacent spokes and the inner edge of said rim, each said window having a second rib;
said first body coupled to said second body with both said inner sides facing each other, said first body and said second body coupled along a fragmented seam;
said fragmented seam being sealed; and
said bearing disposed in said wheel hub.

12. The wheelbarrow of claim 11 wherein:
said first body and said second body both being at least partially convex;
said first body and said second body coupled at a continuous seam disposed at said first body rim and said second body rim; and
whereby, when coupled, said first body and said second body define a sealed, enclosed space.

13. The wheelbarrow of claim 12 wherein:
each said first body first rib and each said second body second rib are inwardly extending ribs;
each said first body first rib and each said second body second rib extending substantially about each associated window;
each said first body first rib extends further inwardly than said second body second rib; and
said first body and said second body being coupled to each other with said first body spokes being aligned with said second body spokes and with each said first body first rib being sealingly folded over each aligned second body second rib.

14. The wheelbarrow of claim 13 wherein:
said second body second rib extends in a plane substantially perpendicular to said second body hub axis of rotation;
said first body first rib having three portions, a proximal portion, a transition portion, and a distal portion;
said first body first rib proximal portion extending in a plane substantially perpendicular to said first body hub axis of rotation;
said first body first rib proximal transition portion extending and bending over said second body second rib; and
said first body first rib distal portion extending in a plane substantially parallel to, but spaced from, said first body first rib proximal portion.

15. The wheelbarrow of claim 12 wherein:
each said first body first rib and said second body second rib are axially inwardly extending ribs, each said first body first rib and said second body second rib being positioned so that when said windows are aligned, each said first body first rib is substantially aligned with an opposing second body second rib; and
wherein, when said first body and said second body are coupled, each said first body first rib and each said second body second rib is coupled to an opposing rib.

16. The wheelbarrow of claim 15 wherein each said first body first rib and each said second body second rib are directly coupled to each other.

17. The wheelbarrow of claim 15 wherein each said first body first rib and each said second body second rib extending substantially about each associated window.

18. The wheelbarrow of claim 15 wherein:
each said first body first rib and each said second body second rib extending partially about each associated window; and
each said first body first rib and each said second body second rib being complimentary to each other.

19. The wheelbarrow of claim 18 wherein each said first body first rib and each said second body second rib extend over about half of each associated window perimeter.

20. The wheelbarrow of claim 12 wherein:
each said first body first rib and each said second body second rib are inwardly extending ribs;
each said first body first rib and each said second body second rib extending substantially about each associated window;
each said first body first rib and said second body second rib extending substantially the same distance into the associated window;
a plurality of grommets, said grommets being loops shaped to correspond to said windows;
one said grommet disposed in each said window and sealingly engaging both said first body first rib and said second body second rib in each associated window.
